(19) United States
(12) Patent Application Publication
(10) Pub. No.: US 2008/0260033 A1
(43) Pub. Date: Oct. 23, 2008

(54) Hybrid hierarchical motion estimation for video streams

(75) Inventors: Ofer Austerlitz, Tel-Mond (IL); Gedalia Oxman, Tel-Aviv (IL); Michael Khrapkovsky, Herzlia (IL); Shay Landis, Hod-HaSharon (IL); Ilan Dimnik, Rishon-LeZion (IL); Amir Morad, Tel-Aviv (IL); Leonid Yavits, Herzlia (IL)

Correspondence Address: Martin D. Moynihan;PRTSI, Inc., P.O. Box 16446, Arlington, VA, 22215, US

(73) Assignee: Horizon Semiconductors Ltd., Herzlia (IL)

(21) Appl. No.: 11/785,396

(22) Filed: Apr. 17, 2007

(51) Int. Cl. H04N 11/04

(52) U.S. Cl. 375/240.16; 375/E07.114; 375/E07.125

(57) ABSTRACT

A method for estimating image-to-image motion of a pixel block in a stream of images which includes a current image which includes the pixel block and a reference image, the method including performing a hierarchical search in a search area of the reference image, including producing a decimated reference image and a decimated pixel block, searching for a location in the search area of the decimated reference image which best fits the decimated pixel block, repeating the producing and the searching for more than one level of hierarchy, determining a first candidate location in the reference image which corresponds to the best fitting location, determining a second candidate location in the reference image by a method other than the hierarchical search, performing a search in the reference image for refined locations of the first and the second candidate locations, selecting one final location from the refined candidate locations, and using the final location for estimating the motion. Related apparatus and methods are also described.

### FIELD OF THE INVENTION

The present invention relates to motion estimation and, more particularly, but not exclusively to motion estimation in video streams.

### BACKGROUND OF THE INVENTION

Motion estimation in video streams is a method for finding, or predicting, motion vectors. The motion vectors describe motion of blocks of pixels within a picture relative to the position of the blocks in previous and in future pictures, termed reference pictures. The motion is normally estimated in a certain search window, also referred to as a search area or a search range, within the reference pictures. The search window can comprise an entire reference picture, or a portion thereof. The size of the search range strongly affects compression quality of the video streams, mainly when the video contains high motion scenes, and especially in high resolution video.

The term “picture” in all its forms is used throughout the present specification and claims interchangeably with the term “image” and its corresponding forms.

The term “motion picture” in all its forms is used throughout the present specification and claims interchangeably with the term “video” and its corresponding forms.

Commonly used video compression standards, such as MPEG2, MPEG4 part 2, VC1 (SMPTE 421M), H.263, DivX, AVS, VP6, and mainly MPEG 4 part 10 (AVC, H.264) use block-matching motion estimation and allow numerous options for estimating motion of a block of pixels inside a picture. For example, a block can be searched in a field (interlaced mode) or in a frame (progressive mode), the block can be divided into various partitions and sub partitions which can be searched separately, and the motion can be searched for in different reference pictures.

To find optimal motion vectors, it is customary to calculate a block prediction error for each motion vector within a certain search range, and pick the block prediction error which has a best compromise between an amount of error and a number of bits needed for motion vector data. A block matching criterion is usually a Mean of Absolute Differences (MAD). More details can be found in related literature, see for example “Digital Video Processing” by A. Murat Tekalp, published in 1995 by Prentice Hall.

A motion estimation method of simply exhaustively testing all possible motion representations to perform such an optimization is called full search. The full search motion estimation method consumes significant computational resources and memory bandwidth, especially when a large search range is scanned and when numerous sub-blocking motion vectors and several reference frames are used for each block of pixels. As a result, several methods were developed over the years with the goal of reducing complexity of motion estimation, as compared with full search, with a minimal degradation of the compression quality. Some methods comprise searching over part of the search range in a first stage(s) and in a later stage(s) refining the search around a best location. Examples of such search methods are “Three Step Search”, and “Cross Search”, described in “Digital Video Processing” by A. Murat Tekalp. An additional search method example called “Diamond Search” was introduced by S. Zhu and K. K. Ma in “A new diamond search algorithm for fast block motion estimation” published in IEEE Trans. Circuits Syst. Video Techno., Vol. 9, pp. 287-290, February 2000.

Hierarchical motion estimation is another method for finding an optimal motion vector in fast motion scenes. Hierarchical motion estimation is sub-optimal compared to the full search methods, uses a coarse search grid for a first approximation, and refines the coarse search grid in a vicinity of the approximation in further steps, up to full-pixel resolution, or even sub-pixel resolution. In an n-stage hierarchical motion estimation, stage i operates on a lower resolution version of a picture than stage i+1, and each stage performs a finer search around a best location found at a prior stage. Hierarchical Motion Estimation is detailed in “Digital Video Processing” by A. Murat Tekalp. A three stage hierarchical motion estimation is described in U.S. Pat. No. 5,761,398.

Reference is now made to FIG. 1, which is a simplified illustration useful for understanding a prior art hierarchical motion estimation method. FIG. 1 depicts a 2-stage hierarchical motion estimation method.

Initially, a current image (not shown) and a reference image 100 are both decimated, that is, resolution of the current image and the reference image 100 is lowered, producing a decimated current image (not shown) and a decimated reference image 105.

In a first stage, a search is conducted for possible motion vectors by searching in a K×L location search area 110, searching for a best fit location of a decimated pixel block of the decimated current image to any of K×L locations of equal sized decimated pixel blocks of the decimated reference image 105. For example, a best fit location 115 is found as a result of the search on the first stage.

In a second stage, searching is performed around the best fit location found in the first stage, using image blocks from the current image (not shown) and the reference image 100 at their original resolution. By way of the above example, the best fit location according to the first stage is best fit location 115 in the decimated reference image 105, corresponding to a location 120 in the reference image 100. After the second stage search, the best fit location 125 is found to be a better fit.

The best fit location 125 is used to determine a motion vector, having a base located at image coordinates of a location of the pixel block in the current image, and a head located at image coordinates of the best fit location 125.

Reference is now made to FIG. 2, which is a simplified illustration providing more details useful for understanding the prior art hierarchical motion estimation method. FIG. 2 illustrates in more detail a generic way of performing the search according to the first stage of FIG. 1, or according to the first n−1 stages of an n-stage hierarchical motion estimation.

A current image (not shown) and a reference image (not shown) are both decimated, as described above with reference to FIG. 1. A decimated current image (not shown) and a decimated reference image 200 are produced. The search is performed by matching a decimated n×m pixel block 205 Cn,m of the decimated current image to decimated pixel blocks (Rn+1,m+1 to Rn+K,m+L) located inside a K×L search range 210 in the decimated reference image 200.

The search range 210 contains K×L search locations, and in each of the search locations a matching function f(C, R) is calculated. The matching function f(C, R) receives as inputs C, representing the n×m pixels inside the decimated pixel block 205 Cn,m, and R, representing the n×m pixels of a specific Rn+i,m+j (1≦i≦K, 1≦j≦L). The matching function f(C, R) outputs a cost, usually in terms of rate-distortion. Rate-distortion is a measure well known in the art, used to combine a compression quality and a compressed stream bit rate into a single unified parameter. It is appreciated by persons skilled in the art that distortion can be derived from a difference between the n×m decimated pixel block 205 Cn,m and the R block, such as, by way of a non-limiting example, a Sum of Absolute Differences (SAD).

A location where the matching function reaches a minimum, is selected to be transferred to a next hierarchy level.

Persons skilled in the art will appreciate that when the n×m pixel block Cn,m 205 is shifted among K×L locations in the decimated reference image 200, a total search area 220 of K+n−1×L+m−1 pixels is searched. Each of the search locations provides a decimated pixel block Rn+i,m+j 225 as one input to the matching function 230, while a second input to the matching function 230 is the decimated pixel block Cn,m 205. A selection is made of a best fit, for example minimal SAD, and the location of the best fit is output 235, to be transferred to a next hierarchy level.

A form of hybrid hierarchical motion estimation is described in U.S. Pat. No. 5,731,850. In the patent a certain threshold is established. If a size of a search range is above the threshold, a hierarchical block-matching search is performed. If the size of the search range is equal to or below the established threshold, a full-search block-matching search is performed.

The following references are believed to represent the state of the art:
“Digital Video Processing” by A. Murat Tekalp, published in 1995 by Prentice Hall;
an article by S. Zhu and K. K. Ma titled “A new diamond search algorithm for fast block motion estimation”, published in IEEE Trans. Circuits Syst. Video Techno., Vol. 9, pp. 287-290, February 2000;
U.S. Pat. No. 5,761,398 to Legall; and
U.S. Pat. No. 5,731,850 to Maturi et al.

The disclosures of all references mentioned above and throughout the present specification, as well as the disclosures of all references mentioned in those references, are hereby incorporated herein by reference.

### SUMMARY OF THE INVENTION

The present invention seeks to provide an improved Hybrid Hierarchical Motion Estimation method, an improved method to perform decimated search, a method to reduce memory bandwidth required for execution of motion estimation search, and an improved hardware architecture for implementing the methods.

According to one aspect of the present invention there is provided a method for estimating image-to-image motion of a pixel block in a stream of images, the stream including a current image which includes the pixel block and a reference image, the method including performing a hierarchical search for a first candidate location in a search area of the reference image, the hierarchical search including producing a decimated instance of the reference image and a decimated instance of the pixel block, searching for a location in the search area of the decimated instance of the reference image which best fits the decimated instance of the pixel block, thereby producing a best-fitting location, and repeating the producing and the searching for more than one level of hierarchy, wherein in a lower level of hierarchy, the producing is repeated at a decreased decimation factor, and the searching is performed in a search area based, at least in part, on the best-fitting location from a higher level of hierarchy, determining a first candidate location in the reference image which corresponds to the best fitting location, determining a second candidate location in the reference image, the second candidate location determined by a method other than the hierarchical search, performing a search in the reference image for refined locations of the first candidate location and the second candidate location, thereby producing refined candidate locations, selecting one final location from the refined candidate locations, and using the one final location for estimating the motion.

According to another aspect of the present invention there is provided an encoder configured for compressing video, the encoder including a motion estimator for estimating image-to-image motion of a pixel block in a stream of video images, the stream including a current image which includes the pixel block and a reference image, the motion estimator including a hierarchical search unit for performing a hierarchical search, at more than one hierarchical level, for a first candidate location in a search area of the reference image, the hierarchical search unit including a decimation unit for producing a decimated instance of the reference images and a decimated instance of the pixel block at a decimation factor decreasing according to the hierarchical level, and a search unit for searching for a location in the search area of the decimated instance of the reference image which best fits the decimated instance of the pixel block, thereby producing a best fitting location, wherein the search area of a lower level of hierarchy is determined based, at least in part, on the best-fitting location from a higher level of hierarchy, a first candidate unit for determining a first candidate location in the reference image which corresponds to the best fitting location, a second candidate unit for determining a second candidate location in the reference image, the second candidate location determined by a method other than the hierarchical search, a refined search unit for performing a search in the reference image for refined locations of the first candidate location and the second candidate location, thereby producing refined candidate locations, a selecting unit for selecting one final location from the refined candidate locations, and a motion estimating unit for using the final location for estimating the motion.

According to yet another aspect of the present invention there is provided a method of producing at least one shifted decimated instance of a pixel block from a portion of an image, including modifying the portion of the image by applying an anti-aliasing filter, and repeating, for at least one instance of integers i, j, D, and E, where 0≦i<D and 0≦j<E shifting a pixel block in the modified portion of the image by i pixels horizontally, and by j pixels vertically, and decimating the shifted modified pixel block by a factor of D horizontally and by a factor of E vertically.

According to another aspect of the present invention there is provided a method of comparing an instance of a first pixel block from a first image to an instance of a second pixel block in a search area in a second image, including producing a shifted decimated instance of the first pixel block from the first image by modifying a portion of the first image including the first pixel block by applying an anti-aliasing filter, by shifting the modified first pixel block, and by decimating the shifted modified first pixel block, producing a shifted decimated instance of a second pixel block from the search area in the second image by applying an anti-aliasing filter, by shifting the modified second pixel block, and by decimating the shifted modified second pixel block, and comparing the instance of the first pixel block to the instance of the second pixel block.

According to yet another aspect of the present invention there is provided a method of producing at least one shifted decimated instance of an n-dimensional block from a portion of an n-dimensional array, including modifying the portion of the n-dimensional array by applying an anti-aliasing filter, and repeating, for at least one instance associating a decimation factor with each of the n dimensions of the n-dimensional array, shifting an n-dimensional block in the modified portion of the n-dimensional array by a number of pixels in each dimension, the number of pixels being smaller than the decimation factor associated with the dimension, and decimating the shifted modified n-dimensional block in each of the n dimensions by the decimation factor associated with the dimension.

According to another aspect of the present invention there is provided a method of scanning a first image included of pixels arrayed in M rows of N macroblocks, in order to search a second image in a search area including macroblocks corresponding to the macroblocks of the first image, the method including the steps of (A) loading into search memory b vertically adjacent macroblocks of the first image including a top left macroblock of the first image, where b>1, and loading into search memory the search area of the second image associated with the b macroblocks of the first image, (B) performing the search for the b vertically adjacent macroblocks of the first image in the search area of the second image, (C) loading into search memory b vertically adjacent macroblocks of the first image immediately to the right of the macroblocks searched in step (B), and loading into search memory the search area of the second image associated with the b macroblocks of step (C), (D) repeating steps (B) and (C) until the first image has been scanned horizontally, including performing the search for the rightmost b vertically adjacent macroblocks to be loaded, (E) loading into search memory b vertically adjacent macroblocks including a top left macroblock of an unscanned portion of the first image and loading into memory the search area of the second image associated with the b macroblocks of step (E), and (F) repeating steps (B) (C) (D) and (E) until the first image has been completely scanned.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified illustration useful for understanding a prior art hierarchical motion estimation search method;

FIG. 2 is a simplified illustration providing more details useful for understanding the prior art hierarchical motion estimation method;

FIG. 3A is a simplified flowchart illustration of a method for producing a Shifted Decimated pixel block operative in accordance with a preferred embodiment of the present invention;

FIG. 3B is a simplified illustration useful for understanding a Hybrid Hierarchical Motion Estimation search method operative in accordance with an alternative preferred embodiment of the present invention;

FIG. 3C is a simplified flowchart illustration of the method of FIG. 3B;

FIG. 4 is a simplified illustration useful for understanding the method of FIG. 3B operative in conjunction with the method of FIG. 3A;

FIG. 5 is a simplified illustration useful for understanding a prior art raster scan scheme;

FIG. 6 is a simplified illustration useful for understanding a jigsaw scan method operative in accordance with another alternative preferred embodiment of the present invention; and

FIG. 7 is a simplified flowchart illustration of the jigsaw scan method of FIG. 6.

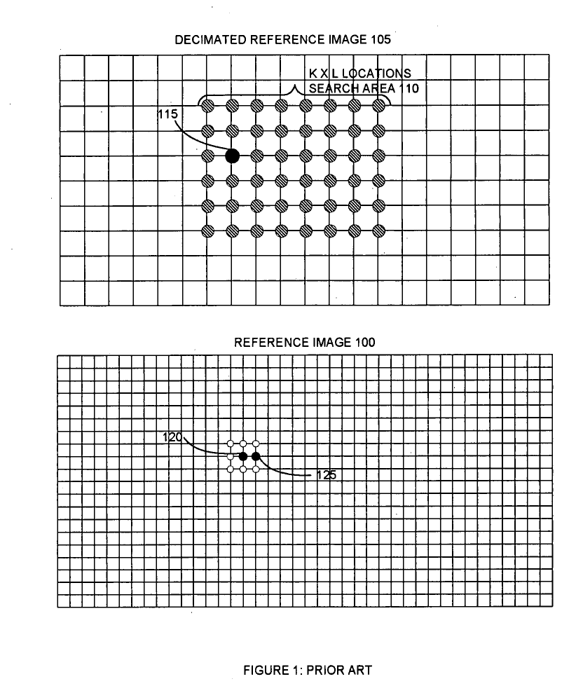

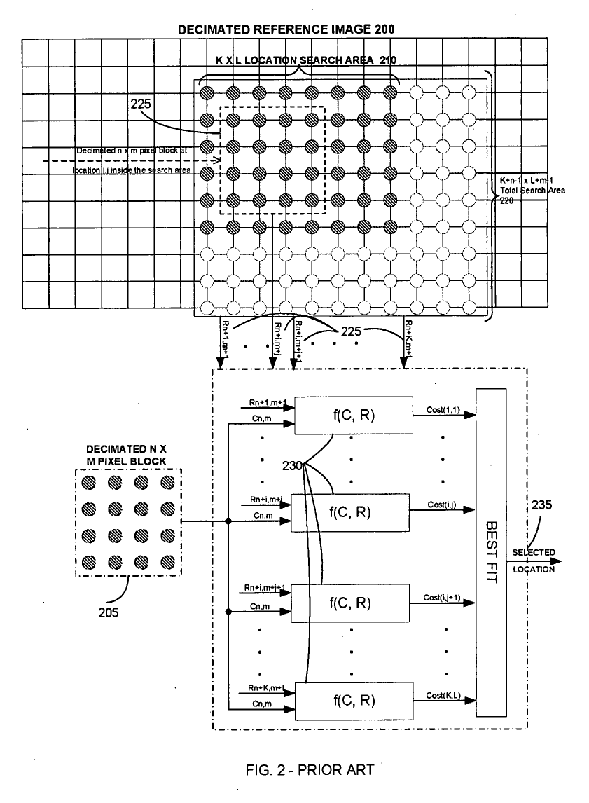

### DESCRIPTION OF PREFERRED EMBODIMENTS

The present embodiments comprise an apparatus and a method for implementing a motion estimation method, used to find a dominant temporal movement of pixel blocks within a picture relative to one or more reference pictures. Preferred embodiments of the present invention describe motion estimation architecture and methods for improved motion search implementation in hardware.

In a preferred embodiment of the present invention, motion estimation is implemented by a hybrid architecture which comprises a hierarchical search for a location where a pixel block has moved, and a full-pixel, or sub-pixel, resolution search around additional candidate locations not produced by the hierarchical search. A resulting motion vector is obtained by selecting a best location from the candidate locations, according to certain matching or cost criterion, and determining a motion vector based on an origin of the pixel block and the best location.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The Hybrid Hierarchical Motion Estimation (HHME) performs a first stage search by matching pixels of a current decimated image block with pixels of a decimated reference image or decimated search area within the reference image, decimated by a same decimation factor. The pixels of the current decimated image comprise one or more blocks of decimated pixels, each block of decimated pixels comprising one or more decimated pixels, each decimated pixel representing several pixels in the original image.

The decimation factor is flexible, and can be 1, which means no decimation, 2, 4, 8 or larger. The decimation factor is not necessarily a multiple of 2. In an alternative preferred embodiment of the present invention, a different decimation factor can be used for a horizontal and for a vertical decimation of the image. In a preferred embodiment of the present invention, each decimated block of pixels from the current image is represented by several spatially shifted blocks, produced during the decimation process.

Equation (1) below is a general decimation equation for a two dimensional image f, using a two dimensional decimation filter h. Output of a decimator is a down-scaled image g, after decimation by a factor of D horizontally and by a factor of E vertically. In a preferred embodiment of the present invention, D and E are integers.

$$\text{Equation (1):}$$

$$g ( m , n ) = {\sum }_{k} {\sum }_{l} f ( k , l ) h ( Dm - k , En - l )$$

By taking m′=Dm and n′=En, Equation (1) is replaced by the following two Equations:

$$\text{Equation (2):}$$

$$\tilde{g} ( {m}^{′} , {n}^{′} ) = {\sum }_{k} {\sum }_{l} f ( k , l ) h ( {m}^{′} - k , {n}^{′} - l )$$

$$\text{Equation (3):}$$

$$g ( m , n ) = \tilde{g} ( Dm , En )$$

Equations (2) and (3) together define a decimator, where Equation (2) comprises an anti-aliasing filter, and Equation (3) is a down-sampling operation.

In a preferred embodiment of the present invention, the following Equations are used for decimation:

$$\text{Equation (4):}$$

$$\tilde{g} ( {m}^{′} , {n}^{′} ) = {\sum }_{k} {\sum }_{l} f ( k , l ) h ( {m}^{′} - k , {n}^{′} - l )$$

$$\text{Equation (5):}$$

$$g ( m , n ) = \tilde{g} ( Dm + i , En + j )$$

$$where \text{:} 0 \leq i \leq D - 1 , 0 \leq j \leq E - 1$$

It is to be appreciated that in preferred embodiments of the present invention, i and j of Equation (5) are not necessarily zero. The i of Equation (5) ranges from zero to D−1, where D is a horizontal decimation factor, and the j of Equation (5) ranges from zero to E−1, where E is a vertical decimation factor.

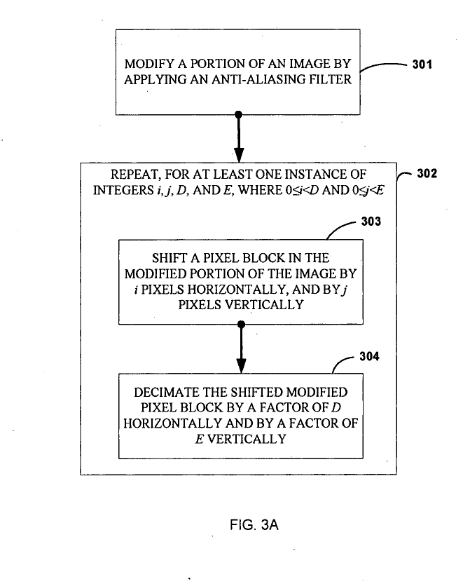

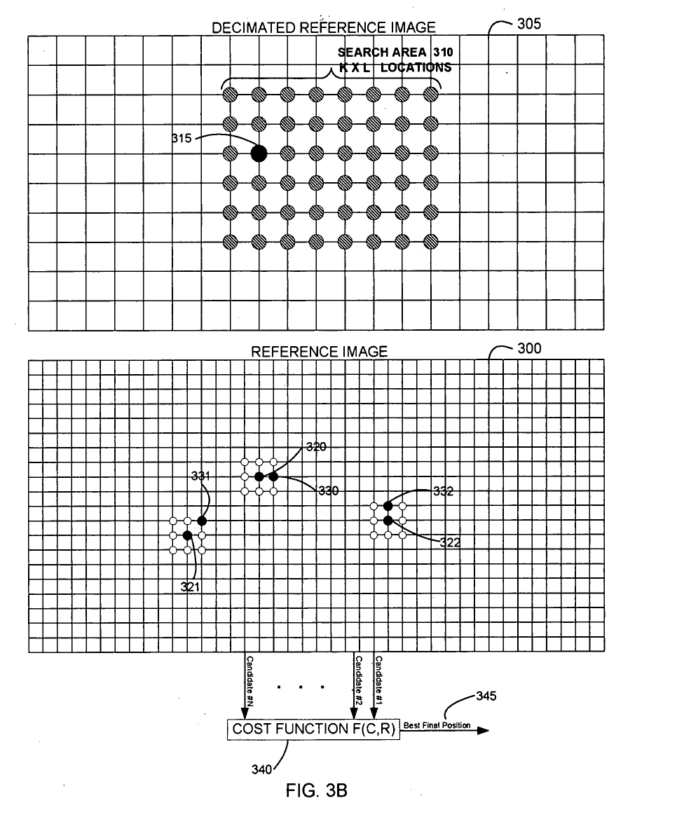

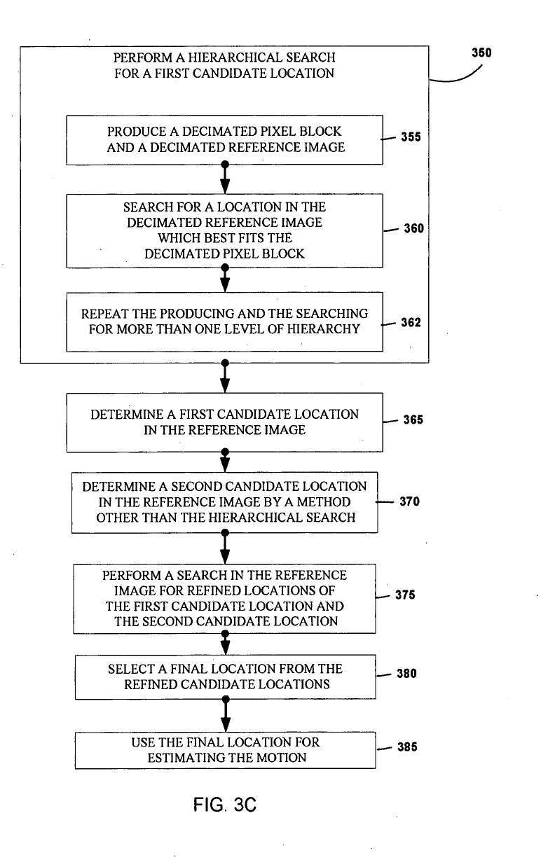

Reference is now made to FIG. 3A, which is a simplified flowchart illustration of a method for producing a Shifted Decimated pixel block operative in accordance with a preferred embodiment of the present invention.

As described above, in order to produce a shifted decimated instance of a pixel block in an image, the image is modified by applying an anti-aliasing filter (step 301). It is to be appreciated that possibly only a portion of the image may be modified, the portion containing the pixel block and shifted instances of the pixel block.

Typically, it is desirable to produce more than one instance of the shifted decimated pixel block (step 302), each of the instances shifted by a different combination of i and j, i being an extent of a shift, in pixels, in a horizontal direction, and j being the extent of the shift, in pixels, in a vertical direction (step 303). It is to be appreciated that 0≦i<D, where D is a horizontal decimation factor, and 0≦j<E, where E is a vertical decimation factor.

The modified pixel block from the modified image is then decimated by a factor of D horizontally and E vertically (step 304).

It is to be appreciated that steps 303 and 304 can be done at the same time in a single operation representing Equation 5 above.

It is to be appreciated that each of the instances is shifted by a different number of pixels relative to the location of the pixel block in the image, the number of pixels being smaller than the decimation factor in the direction of the shifting.

It is to be appreciated that the pixel block can be of any size, including, by way of a non-limiting example, an entire image frame; an entire image field; a macroblock, according to any compression standard which uses macroblocks; several macroblocks; a portion of the macroblock; a portion of a portion of the macroblock; and a combination of portions of macroblocks.

The term “macroblock” in all its grammatical forms is used throughout the present specification and claims interchangeably with the term “pixel block”, and without limitation to a specific size of the macroblock.

It should also be appreciated that the shifted decimation method described herein is applicable to other methods, algorithms and applications using decimation of two dimensional arrays and not only in decimation of a block of pixels.

Person skilled in the art will appreciate the fact that the two dimensional method presented here can be easily expanded to an n-dimensional method, to be used for shifted decimation of an n-dimensional array

In an alternative preferred embodiment of the present invention, the i and j used for decimation of reference image(s) are not equal to the i and j used for decimation of the current image.

In yet another alternative preferred embodiment of the present invention, several i's and j's can be used to create multiple decimation instances of a same image, each decimation instance spatially shifted relatively to the other. It is to be appreciated that when i and j in Equation (5) are both zero, motion search between the decimated current image and the decimated reference image is practically optimized to find a horizontal movement of N1*D pixels and a vertical movement of N2*E pixels, where N1 and N2 are integers. In other words, motion estimation on the decimated images is optimized to find motion movements that are an integer multiplication of the decimation factors D and E. Naturally, actual motion between images and between different sections within images is not necessarily an integer multiplication of the decimation factors. By using different i and j values in Equation (5), a probability of finding an optimized motion vector between the decimated images increases, quality of the motion estimation increases, and quality of an encoder based on such motion estimation is better.

The process described above, which uses i and j values in Equation (5) which are not necessarily zero shall be referred to hereunder as Shifted Decimated Search (SDS).

SDS can be used in a first stage of Hierarchical Motion Estimation, and in other stages using decimated images, by producing and using shifted decimated instances of the reference image(s), by producing and using shifted decimated instances of pixel blocks of the current picture, and by producing and using both shifted decimated instances of the reference images and shifted decimated instances of the pixel blocks of the current picture. The shifted decimated instances are produced by using different i and j values in Equation (5).

In a preferred embodiment of the present invention, the shifted decimated instances are produced with all valid i and j values of Equation (5).

In an alternative preferred embodiments of the present invention the shifted decimated instances are produced with only some of the valid i and j values of Equation (5). By way of a non-limiting example, producing shifted decimated instances for a variety of valid j values where i=0, producing shifted decimated instances for a variety of valid i values where j=0, producing shifted decimated instances for a variety of valid i and j values where i=j, and so on.

Each combination of decimated instances can be used for searching of the best motion estimated location, and thus for determining a motion vector.

In a preferred embodiment of the present invention, each shifted decimated instance of a pixel block of a current image is searched over the entire search range within each shifted decimated instance of the reference image(s). When a best match location is found per each pair of reference-current shifted decimated instances, the best of all pairs is selected as a candidate for a next stage of the hierarchical search.

In an alternative preferred embodiment of the present invention, a plurality of candidate locations from a plurality of shifted decimation instances are selected as candidates for a next stage of the hierarchical search.

In yet another alternative preferred embodiment of the present invention not all shifted decimated instances of the pixel blocks of the current image are searched over all shifted decimated instances of the reference image. Only a portion of the shifted decimated instances of the pixel blocks of the current image are searched, preferably in a first shift pattern, and only a portion of the shifted decimated instances of the reference image are searched, preferably in a second shift pattern. The first shift pattern and the second shift pattern may or may not be equal. Some non-limiting examples of shift patterns are described below.

In another preferred embodiment of the present invention, a decision of which shifted decimated instance is used for search is determined dynamically. Different shift patterns may be chosen for different images, for different areas within an image, for different groups of pixel blocks within the image, and for each block of pixels within the image. By way of a non-limiting example, in one shift pattern the search uses horizontal shifted decimated instances in a certain image area and in a second shift pattern the search uses vertical shifted decimated instances in another image area. Another non-limiting example uses more shifted decimated instances when estimating motion of a certain image area and uses less shifted decimated instances when estimating motion of other image areas.

In yet another preferred embodiment of the present invention, the decision as to which shift pattern is used for search is pre-determined. A non-limiting example of a pre-determined shift pattern can be any one of the above-mentioned shift patterns, or any other shift patterns.

Reference is now made to FIG. 3B, which is a simplified illustration useful for understanding a Hybrid Hierarchical Motion Estimation search method operative in accordance with an alternative preferred embodiment of the present invention.

FIG. 3B illustrates a simple example of two stage hybrid hierarchical motion estimation.

Initially, a current image (not shown) and a reference image 300 are both decimated, that is, resolution of the current image and the reference image 300 is lowered, producing a decimated current image (not shown) and a decimated reference image 305.

In a first stage, a search is conducted for possible motion vectors by searching in a K×L location search area 310, searching for a best fit location of a decimated pixel block of the current image to any of K×L locations of equal sized decimated pixel blocks of the decimated reference image. For example, a best fit location 315 is found as a result of the search on the first stage, using a specific best fit criterion, such as, by way of a non-limiting example, minimal SAD. Another non-limiting example of a best fit criterion is minimal sum of squares of differences. It is to be appreciated that other best fit criteria exist, some of them well known in the art, such as, by way of a non-limiting example, rate-distortion, combining an expected cost of the SAD and a cost of the accompanying motion vector.

The best fit location 315 is selected as a candidate location for further refined searching.

It is to be appreciated that the current image (not shown) and the reference image 300 can be image frames, and the current image and the reference image 300 can be image fields. Image frames are typically used when the images are in a progressive scan mode video stream, and image fields are typically used when the images are in an interlaced scan mode video stream.

In an alternative preferred embodiment of the present invention, the search for a best fit location 315 is repeated in more than one instance of a decimated reference image 305. The more than one instance of a decimated reference image 305 are produced from more than one reference image selected from the image stream comprising the current image.

In a second stage, searching is performed around the candidate best fit location 315 found in the first stage, as well as additional candidate locations predicted by one or more additional criteria. The prediction of additional candidate locations by additional criteria is now described.

In a preferred embodiment of the present invention, one or more search locations are predicted by motion estimated for neighboring blocks of the current block of pixels, or neighboring blocks of neighbors of the current block of pixels, or neighboring blocks of a related macroblock of the current block of pixels.

In an alternative preferred embodiment of the present invention, one or more search locations are predicted by different modes of compression of the same block of pixels. By way of a non-limiting example, in the MPEG 4 part 10 (H.264) standard, field mode search locations can be predicted from frame mode location; block partition locations can be predicted from block locations. By way of a non-limiting example, an 8×16 block partition location is predicted from a 16×16 block location which comprises the 8×16 block; sub-partition locations are predicted from the block partition locations, such as predicting a 4×4 sub-partition location from an 8×8 block partition location and from a 16×16 block location.

In yet another alternative preferred embodiment of the present invention, one of the search locations inside the reference picture is simply the same relative location of the pixel block in the current picture.

In another preferred embodiment of the present invention, more than one candidate coming from the previous hierarchical level, or from F(C, R), can be used for each current pixel block. By way of a non-limiting example, MPEG compression allows use of different compression modes, such as field and frame, per image. In fact, MPEG allows different compression modes for different groups of blocks of pixels within an image, for different macroblocks, and even for different portions of a macroblock. A plurality of candidate locations are used for searching, such as, by way of a non-limiting example, a candidate location for each compression mode used in an image. In yet another non-limiting example, several candidates from different shifted decimation instances, searched in a previous hierarchical level, are used as locations for searching in a present hierarchical level.

In preferred embodiments of the present invention, all, part or none of the above search location prediction methods, and any combination thereof, are used.

The second stage search is performed comparing image blocks from the current image (not shown) and the reference image 300 at a higher resolution than that of the decimated reference image 305. In the non-limiting example of FIG. 3B, the second stage search is performed at full image resolution.

Persons skilled in the art will appreciate that a search can be performed at full image resolution, and can produce search results at the original pixel resolution. The search can even be performed using an interpolated pixel block and an interpolated reference image, to search images at a higher resolution than original images, by way of a non-limiting example, at half pixel, quarter pixel and even below quarter pixel, and produce search results at higher accuracy than one pixel of the original images.

By way of the above example, the best fit location according to the first stage is the best fit location 315 in the decimated reference image 305, corresponding to candidate location 320 in the reference image 300. The second stage search is also performed around two more candidate locations 321 322 arrived at by using other candidate location selection methods. After the second stage search, refined candidate locations 330 331 332 are each found to be a better fit than their parent candidate locations 320 321 322.

The refined candidate locations 330 331 332 are again measured by a cost function 340, which selects a final location 345.

The final location 345 is used to determine a motion vector, the motion vector having a base located at image coordinates of a location of the pixel block in the current image, and a head located at image coordinates of the final location 345.

In preferred embodiments of the present invention, the HHME comprises one hierarchical stage, two hierarchical stages, or more than two hierarchical stages, where each stage may have a different decimation factor.

Reference is now made to FIG. 3C, which is a simplified flowchart illustration of the method of FIG. 3B.

In a preferred embodiment of the present invention, in order to estimate an image-to-image motion of a pixel block in a stream of images, the following steps are performed.

A hierarchical search is performed for a first candidate location in a search area of the reference image (step 350).

Performing the hierarchical search comprises producing a decimated instance of the reference image and a decimated instance of the pixel block (step 355). The decimation is performed by a same decimation factor for the pixel block and the reference image. The decimation factor is not necessarily the same in the horizontal direction as in the vertical direction.

Having produced the decimated instance of the reference image and the decimated instance of the pixel block (step 355), a search is performed for a location in the search area of the decimated instance of the reference image which best fits the decimated instance of the pixel block (step 360).

It is to be appreciated that the hierarchical search as described above, comprising producing a decimated pixel block and a decimated reference image, and searching for a best fit location, is typically performed more than once. The decimation is preferably performed at decreasing factors of decimation on each repetition. The search area within which a search for a best fit location is performed at one level of hierarchy is preferably determined based on a vicinity of the best fitting location of a higher level of the hierarchy (step 362).

The location in the search area which best fits the decimated instance of the pixel block determines a first candidate location in the reference image (step 365).

After the hierarchical search and the determination of a first candidate location, a second candidate location in the reference image is determined (step 370). The second candidate location is determined by a method other than the hierarchical search. Possible other methods are described above, with reference to FIG. 3B.

It is to be appreciated that typically more than one second candidate location is determined, typically using more than one method. Persons skilled in the art will appreciate that in the hierarchical search more than one location can be transferred from one level of the hierarchy to another. In the non-limiting example depicted by FIG. 3B, one first candidate location 320 is determined by the hierarchical search, and two more candidate locations 321 322 are determined by other methods.

A search is performed in the undecimated reference image for refined locations of the first candidate location and the second candidate location (step 375), thereby producing refined candidate locations.

It is to be appreciated that the search in the undecimated reference image may be performed in an interpolated instance of the reference image, which has more pixels than the reference image. The search in the interpolated instance of the undecimated reference image preferably produces greater accuracy than the search in a non-interpolated instance of the undecimated reference image.

One final location is preferably selected from the refined candidate locations, the final location usually being the refined candidate location with a best fit of the pixel block to the reference image (step 380).

The final location is used for motion estimation, as is well known in the art (step 385). Typically a motion vector is determined, with the beginning of the motion vector located at image coordinates where the pixel block is located, and the head of the motion vector located at image coordinates of the final location.

Persons skilled in the art will appreciate that determination of the final location and of the motion vector can be done with sub-pixel accuracy.

It is to be appreciated that the determining of a second candidate location (step 370), and determining more than one second candidate location, can be interwoven into any level of hierarchy in the hierarchical search.

In an alternative preferred embodiment of the present invention, a second candidate location is added at an end of one stage of the hierarchical search, after step 360. The search area at a level of hierarchy after the one stage mentioned above, is preferably determined based on a location of the best fitting location and of the second candidate location. It is to be appreciated that the best fitting location and the second candidate location do not necessarily determine a single search area, and may determine more than one search area, which is used for the search at the next level of hierarchy.

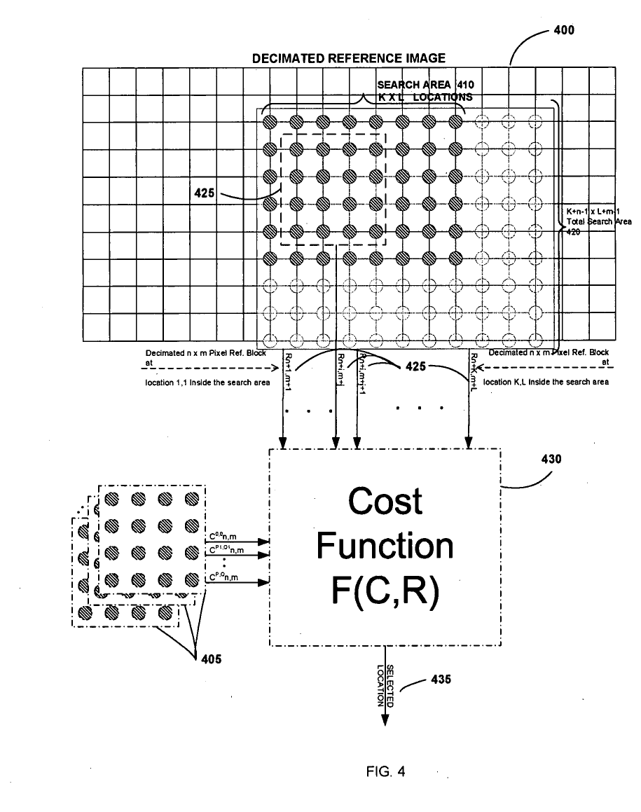

Reference is now additionally made to FIG. 4, which is a simplified illustration useful for understanding the method of FIG. 3B operative in conjunction with the method of FIG. 3A.

FIG. 4 demonstrates, by way of a non-limiting example, a specific case of Shifted Decimated Search (SDS), in which shifted decimated instances of an image block of the current image are used, and shifted instances of the decimated reference image are not used.

A plurality of instances of shifted decimated pixel blocks 405 of the current image are produced, as described above. A decimated reference image 400 is also produced.

It is to be appreciated that not all of the possible shifted decimated pixel blocks 405 which are produced are necessarily used in a search. A preferred embodiment of the present invention supports receiving an external indication as to which portion of the shifted decimated instances of the pixel blocks 405 which are produced is to participate in a search. By way of a non-limiting example, an indication may be received indicating the use of only horizontal shifted decimated instances of the pixel blocks. Such an indication is typically used in cases where an image stream is known to comprise substantially mostly horizontal action. Indication of a more complex portion of the shifted decimated instances of the pixel blocks is also possible.

Persons skilled in the art will appreciate that when an indication is used to limit the search to a portion of the shifted decimated pixel blocks 405, a similar indication can be given to use a portion of shifted decimated instances of the reference image, when a plurality of shifted decimated instances of the reference image are used.

Each of the instances of the shifted decimated pixel blocks 405 comprises n×m pixels, which represent a larger number of un-decimated pixels in the un-decimated current image. Each shifted decimated instance of the n×m pixel block is marked as C^{Pi,Qj}n,m, where Pi and Pj stand for shifts of i and j as referred to in Equation (5). A cost function F(C,R) 430 receives as input all the applicable instances of the shifted decimated pixel block C^{Pi,Qj}n,m 405, as well as blocks of n×m decimated pixels Rn+1,m+1 to Rn+K,m+L 425 from locations in a K×L search area 410 within the decimated reference image. The cost function F(C,R) outputs a selected best location 435 for the current pixel block.

Referring again to FIG. 3B, the candidate location 320 comprises the above-mentioned selected best location. The selected best location is used as a base for a refined search in a next hierarchical step of the HHME algorithm.

Persons skilled in the art will appreciate that the cost function F(C,R) can comprise many instances of pattern matching functions F(C,R). The instances of F(C,R) all preferably receive as input C, representing the n×m pixels in a shifted decimated C^{Pi,Qj}n,m, and R, representing the n×m pixels of Rn+i,m+j, where 1≦i≦K, 1≦j≦L, inside the search range of the decimated reference. The instances of F(C,R) all preferably output a location and a cost for the location, usually in terms of rate-distortion, of the difference between C^{Pi,Qj}nm and Rn+i,m+j.

By way of a non-limiting example, a typical F(C,R) comprises a Sum of Absolute Differences (SAD) function. After comparing all the costs resulting of different C and R inputs, the F(C,R) 430 finds a minimum cost and outputs a best fitting position of the instances of the shifted decimated pixel blocks 405, to be used as a predictor for a search location for the next stages in the hierarchal search.

When more than one decimated instance of the reference picture is used (not depicted in FIG. 4), matching functions of the F(C,R) 430 calculate a cost of each decimated instance of Rn+i,m+j and select a best fitting, lower cost, location to be used in a next stage of the hierarchical search. In an alternative preferred embodiment of the present invention, F(CR) 430 can select more than one best fitting location to be used in a next stage of the hierarchical search, by way of a non-limiting example, the best fitting location of each instance can be used in the next stage.

In a preferred embodiment of the present invention, the selected best location resulting from the cost function F(C,R) 430 is adjusted according to a shift (i, j) of the selected shifted decimated instance of the reference image and according to the shift (i, j) of the selected shifted decimated instance of the pixel block. Since the shift (i, j) of the selected shifted decimated instance of the reference image is not necessarily the same shift (i, j) of the selected shifted decimated instance of the pixel block, hereafter denoted as ir, jr and ic, jc respectively, the selected location coming out of the cost function F(C,R) needs to be adjusted by ir-ic, jr-jc pixels before performing a refined search at a next hierarchical step of the HHME method. By way of a non-limiting example, if the selected location is found by matching a pixel block in the shifted decimated instance of the reference image (ir=1, jr=1) and the current instance (ic=2, jc=3), the selected best location out of F(C,R) will be adjusted by (ir-ic, jr-jc)=(−1, −2) pixel locations.

The entire set of all search locations of a first stage of the HHME comprises a search range, or search area. As shown in FIG. 4, when searching for a best match of a current block of n×m decimated pixels, additional m−1 decimated pixel columns and n−1 decimated pixel rows participate in the search process. In a typical integrated circuit implementation, search area pixels are kept in local internal memory, usually residing on a same silicon die with the search logic, whereas entire images are stored in an external memory. In this case, the search area pixels are transferred from the external memory to the internal memory in order to perform the motion estimation of the current block.

Persons skilled in the art will appreciate that in most video compression standards, such as, by way of a non-limiting example, MPEG2, MPEG4 part 2, MPEG4 part 10, and SMPTE 421M, compression of an image is done in a raster scan, in which the image is divided into blocks of pixels of a known size. The blocks of pixels of a known size, termed macroblocks, are typically square, and are typically 16×16 pixels. In some standards the block of pixels used for the raster scan can be 16×32 pixels. However, the present invention is not limited to a certain number of pixels per block of pixels used for the scan. For simplicity of description of the present invention, the term “macroblock” is used with no limitation to a specific size.

In the above mentioned video compression standards, the macroblocks are usually compressed from an image's top left macroblock to a bottom right macroblock, by raster scan, one row of macroblocks after another.

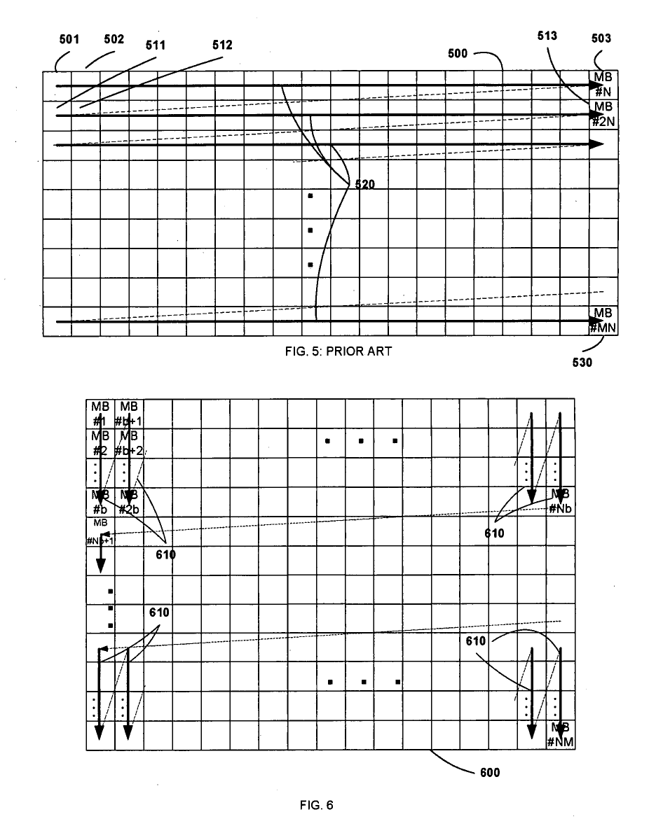

Reference is now made to FIG. 5, which is a simplified illustration useful for understanding a prior art raster scan scheme.

FIG. 5 depicts an image 500 of N×M macroblocks. The macroblocks are numbered from left to right, with a first macroblock 501 at a top left corner of the image 500, a second macroblock 502 to the right of the first macroblock 501, and an N-th macroblock 503 at a right hand end of the image 500. A next row of macroblocks comprises an N+1 macroblock 511 at the left, an N+2 macroblock 512 to the right of the N+1 macroblock 511, and a 2N-th macroblock 513 at the right hand end of the image.

A raster scan follows the arrows, scanning a first row 520, a second row 520, until the bottom row 520 of the image 500. The last macroblock of the image 500 is the M×N macroblock 530.

When compressing a next raster-scanned macroblock belonging to a same row of macroblocks, a search area of the motion estimation includes additional columns, of a width of a decimated macroblock, of reference pixels. Excluding picture boundary effects, the next macroblock in a row requires additional reference pixel columns to the right and less reference pixel columns on the left. In other words, each n×m pixel macroblock, which is not near image boundaries, in a search area of K×L pixels, requires an additional (L+m−1)×n pixels to reside in the search area memory typically comprised in an external memory. For all practical hardware implementations, a size of an image is larger than the size of the search area, and an internal memory can not practically include L+m−1 full image rows for the search area. The internal memory is especially challenged when image resolution is high. Therefore, when switching from one row of macroblocks to the next, the internal memory for the search area needs to be totally replaced by new pixel data from the external memory. On the average, when taking into account boundary effects, each macroblock requires a transfer of (L+m−1)×n pixels from the external memory, thus setting high memory bandwidth requirements. Therefore it would be very advantageous to reduce required bandwidth from the external memory. For that purpose, in a preferred embodiment of the present invention, search is performed in a jigsaw fashion, as depicted in FIG. 6 below.

Reference is now made to FIG. 6 which is a simplified illustration useful for understanding a jigsaw scan method operative in accordance with another alternative preferred embodiment of the present invention.

In the jigsaw scan, we perform a motion estimation search in an image 600, by searching in one group of macroblocks 610 at a time. Each group of macroblocks 610, vertically adjacent to each other, is searched before moving to the next vertical group of macroblocks 610 to the right. FIG. 6 depicts a non-limiting example for a jigsaw scan of a picture that contains N×M macroblocks, each macroblock comprising n×m pixels, with vertical group of b macroblocks. For each group of macroblocks 610 comprising b macroblocks in the jigsaw scan, an average of (L+m−1+(b−1)×m)×n pixels are transferred from the external memory into the internal memory, or an average ((L+m−1+(b−1)×m)×n)/b per macroblock. Therefore, an average bandwidth reduction per macroblock when using the jigsaw scan instead of the regular raster scan is:

$$\text{Equation (6):}$$

$$\frac{( L + m - 1 + ( b - 1 \times m ) \times n / b}{( L + m - 1 ) \times n} = \frac{L + m - 1 + ( b - 1 ) \times m}{b \times ( L + m - 1 )} = \frac{L / m + 1 - 1 / m + b - 1}{b \times ( L / m + 1 - 1 / m )} \approx \frac{1}{b}$$

$$where L / m >> b$$

The approximation of Equation 6 holds true when L/m+1−1/m>>b−1, in other words when L/m, representing a vertical search range in macroblocks, is much larger than b. This is typically the case when the search range is vertically large. As seen in Equation (6), the bandwidth reduction is approximately by a factor of b. In other cases where L/m is not much larger than b but is at least twice as big (L/m>2b), the bandwidth reduction is:

$$\text{Equation (7):}$$

$$\frac{L / m + 1 - 1 / m + b - 1}{b \times ( L / m + 1 - 1 / m )} \leq \frac{3 / 2 \times ( L / m ) - 1 / m}{b \times ( L / m + 1 - 1 / m )} < \frac{3 / 2 \times ( L / m )}{b \times ( L / m + 1 - 1 / m )} < \frac{3}{2 b}$$

$$where L / m \geq 2 b$$

A minimum bandwidth reduction in case of Equation (7) is 25%, for b=2. For b=3 the reduction is 50%. As b grows, the bandwidth reduction of Equation (7) gets closer to the bandwidth reduction of Equation (6), which is a reduction by a factor of b.

A penalty when using the jigsaw scan is additional embedded memory needed for storing (b−1)×m extra rows in the search range, or (b−1)×m×(K+n−1) pixels.

When comparing a ratio between the memory required for the search area for the jigsaw scan and for the raster scan, we get the following:

$$\text{Equation (9):}$$

$$\frac{( L + m - 1 + ( b - 1 ) \times m )}{L + m - 1} = 1 + \frac{( b - 1 ) \times m}{L + m - 1} = 1 + \frac{b - 1}{L / m + 1 - 1 / m}$$

Person skilled in the art will appreciate that when L/m is relatively large compared to b, the ratio is close to 1. In other words, when the vertical search range in macroblocks is relatively large compared to the number of macroblocks in a jigsaw-tooth the additional search area memory required for the jigsaw scan is substantially small.

It is to be appreciated that the jigsaw scan search can be used in any motion estimation algorithm, not necessarily HHME or other decimated or hierarchical motion estimation schemes. Additionally, the jigsaw scan search can be used either to search in a decimated reference image, to search in a normal resolution reference image, and even to search in interpolated and higher resolution reference images.

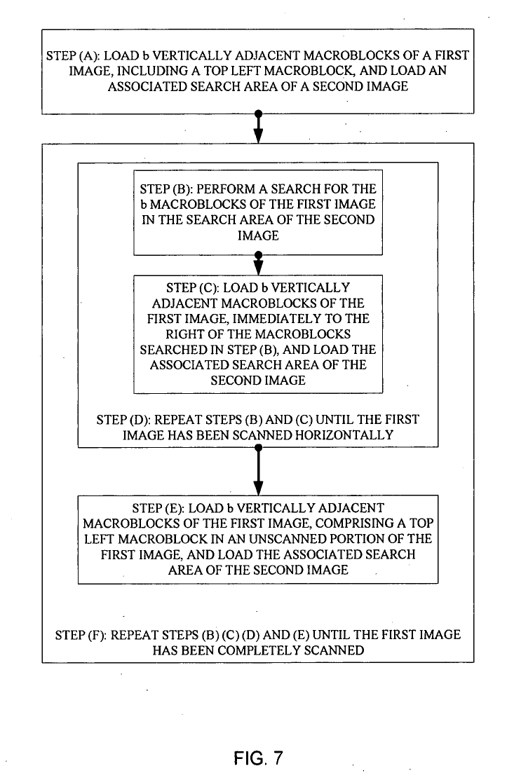

Reference is now made to FIG. 7, which is a simplified flowchart illustration of the jigsaw scan method of FIG. 6.

Given a first image and a second image, and given that the first image comprises N×M macroblocks, a first group of b vertically adjacent macroblocks of the first image, comprising a top left macroblock in the first image, is loaded into search memory. A search area, comprised in the second image and associated with the b macroblocks of the first image, is also loaded into search memory (step A).

Persons skilled in the art will appreciate that the first image is typically referred to as a current image, and the second image is typically referred to as a reference image.

It is to be appreciated that b is preferably greater than 1.

In a preferred embodiment of the present invention, the b vertically adjacent macroblocks of the first image are loaded into the internal memory one after the other, while the search area from the second image, which is loaded into the internal memory, is associated with all b macroblocks of the first image, and preferably loaded together.

A search is performed for the b vertically adjacent macroblocks of the first image in the search area of the second image (step B).

An additional group of b vertically adjacent macroblocks of the first image, from immediately to the right of the macroblocks just searched, is loaded into the search memory, as well as the search area of the second image associated with the b macroblocks of the first image just loaded (step C).

Steps B and C are repeated until the first image has been scanned horizontally, including performing the search for the rightmost b vertically adjacent macroblocks of the first image to be loaded (step D);

b vertically adjacent macroblocks comprising a top left macroblock in an unscanned portion of the first image, and the search area of the second image associated with the b macroblocks, are loaded into search memory (step E).

In a preferred embodiment of the present invention, part of the associated search range of the above-mentioned b vertically adjacent macroblocks, comprising a top left macroblock in an unscanned portion of the first image, is loaded into the internal memory in an earlier stage, for example, and without limiting the generality of the foregoing, while the rightmost b macroblocks of the previous macroblock row is being searched, and even before.

Steps B, C, D, and E are repeated, until the first image has been completely scanned (step F).

It is expected that during the life of this patent many relevant devices and systems will be developed and the scope of the terms herein, particularly of the terms compression, macroblock, motion estimation, hierarchical search, and decimated search, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for estimating image-to-image motion of a pixel block in a stream of images, the stream comprising a current image which comprises the pixel block and a reference image, the method comprising:
performing a hierarchical search for a first candidate location in a search area of the reference image, the hierarchical search comprising:
producing a decimated instance of the reference image and a decimated instance of the pixel block;
searching for a location in the search area of the decimated instance of the reference image which best fits the decimated instance of the pixel block, thereby producing a best-fitting location; and
repeating the producing and the searching for more than one level of hierarchy, wherein in a lower level of hierarchy, the producing is repeated at a decreased decimation factor, and the searching is performed in a search area based, at least in part, on the best-fitting location from a higher level of hierarchy;
determining a first candidate location in the reference image which corresponds to the best fitting location;
determining a second candidate location in the reference image, the second candidate location determined by a method other than the hierarchical search;
performing a search in the reference image for refined locations of the first candidate location and the second candidate location, thereby producing refined candidate locations;
selecting one final location from the refined candidate locations; and
using the one final location for estimating the motion.

2. The method according to claim 1 and wherein the producing a decimated instance of the reference image comprises producing a decimated instance of a portion of the reference image, the portion comprising at least the search area of the reference image.

3. The method according to claim 1 and wherein the performing a hierarchical search comprises searching in a search area based, at least in part, on the best-fitting location from a higher level of hierarchy and on a location determined by the method other than the hierarchical search.

4. The method according to claim 3 and wherein the searching is performed in a search area based, at least in part, on the best-fitting location from a higher level of hierarchy and on more than one location determined by more than one method other than the hierarchical search.

5. The method according to claim 1 and wherein the producing a best-fitting location comprises producing more than one best fitting location, and the searching is performed in a search area based, at least in part, on more than one best-fitting location from a higher level of hierarchy.

6. The method according to claim 3 and wherein the determining a first candidate location comprises determining more than one first candidate location.

7. The method according to claim 1 and wherein the determining a second candidate location comprises selecting more than one second candidate location.

8. The method according to claim 1 and wherein the performing a search in the reference image for refined locations produces refined candidate locations at sub-pixel resolution.

9. The method according to claim 1 and wherein the current image and the reference image comprise image frames.

10. The method according to claim 1 and wherein the current image and the reference image comprise image fields.

11. The method according to claim 1 and wherein:
the performing a hierarchical search for a first candidate location comprises performing a hierarchical search in more than one reference image, thereby producing at least one best fitting location, and the determining a first candidate location comprises determining at least one first candidate location.

12. The method according to claim 1 and wherein the search area comprises the entire reference image.

13. The method according to claim 1 and wherein the pixel block comprises a macroblock according to one of the group of image compression standards consisting of: MPEG2, MPEG4 part 2, VC1, AVC, H.263, AVS, VP6, and DivX.

14. The method according to claim 1 and wherein the pixel block comprises a portion of a macroblock according to one of the group of image compression standards consisting of: MPEG2, MPEG4 part 2, VC1, AVC, H.263, AVS, VP6, and DivX.

15. The method according to claim 1 and wherein the pixel block comprises portions of more than one macroblock according to one of the group of image compression standards consisting of: MPEG2, MPEG4 part 2, VC1, AVC, H.263, AVS, VP6, and DivX.

16. The method according to claim 1 and wherein the search area is a plurality of macroblocks according to one of the group of image compression standards consisting of: MPEG2, MPEG4 part 2, VC1, AVC, H.263, AVS, VP6, and DivX.

17. The method according to claim 1 and wherein the second candidate location is determined based, at least in part, on at least one of the following methods:
(a) determining a second candidate location based on estimating motion of a different pixel block comprised in the current image;
(b) determining a second candidate location based on a location of the pixel block according to a different compression mode than a compression mode in which the search is performed;
(c) determining a second candidate location based on a location of a different pixel block, if the different pixel block is compressed according to a different compression mode than the compression mode in which the search is performed; and
(d) a second candidate location based on a location of the pixel block in the current image.

18. The method according to claim 1 and wherein the pixel block and the reference image are decimated by a first factor horizontally and by a second factor vertically, and wherein the first factor and the second factor are different.

19. The method according to claim 1 and wherein:
the hierarchical search comprises at least two hierarchical stages, each of the stages having a different decimation factor; and
the search area of a later stage in the hierarchical search is determined based, at least in part, on the best fitting location of an earlier stage.

20. The method according to claim 1 and wherein the decimated instance of the reference image is produced by modifying the reference image by applying an anti-aliasing filter, and by decimating the modified reference image, and wherein more than one shifted decimated instance of the reference image is produced, each of the instances being shifted by a different number of pixels, the number of pixels being smaller than the decimation factor in the direction of the shifting.

21. The method according to claim 20 and wherein the hierarchical search is performed using each of the shifted decimated instances of the reference image, thereby determining a plurality of best fitting locations, and selecting one best fitting location based, at least in part, on using a cost function to select one best fitting location from the plurality of best fitting locations.

22. The method according to claim 21 and wherein the hierarchical search is performed using only a portion of the shifted decimated instances of the reference image, the portion being dynamically determined.

23. The method according to claim 21 and wherein the final location for estimating the motion is adjusted according to the number of pixels by which the shifted decimated instance of the reference image corresponding to the final location was shifted.

24. The method according to claim 21 and wherein only some of the shifted decimated instances of the reference image are used in the hierarchical search, and wherein which of the shifted decimated instances of the reference image are used is determined according to a predetermined shift pattern.

25. The method according to claim 1 and wherein the decimated instance of the pixel block is produced by modifying the pixel block of the current image by applying an anti-aliasing filter, and by decimating the modified pixel block, and wherein more than one shifted decimated instance of the pixel block is produced, each of the instances being shifted by a different number of pixels relative to the location of the pixel block in the current image, the number of pixels being smaller than the decimation factor in the direction of the shifting.

26. The method according to claim 25 and wherein the hierarchical search is performed using each of the shifted decimated instances of the pixel block, thereby determining a plurality of best fitting locations, and selecting one best fitting location based, at least in part, on using a cost function to select one best fitting location from the plurality of best fitting locations.

27. The method according to claim 26 and wherein the hierarchical search is performed using only a portion of the shifted decimated instances of the pixel block, the portion being dynamically determined.

28. The method according to claim 26 and wherein the final location for estimating the motion is adjusted according to the number of pixels by which the shifted decimated instance of the pixel block corresponding to the final location was shifted.

29. The method according to claim 26 and wherein only some of the shifted decimated instances of the pixel block are used in the hierarchical search, and wherein which of the decimated instances of the pixel block are used is determined according to a predetermined shift pattern.

30. The method according to claim 1 and wherein:
the decimated instance of the reference image is produced by modifying the reference image by applying an anti-aliasing filter and by decimating the modified reference image;
more than one shifted decimated instance of the reference image is produced, each of the instances being shifted by a different number of pixels, the number of pixels being smaller than the decimation factor in the direction of the shifting;
the decimated instance of the pixel block is produced by modifying the pixel block by applying an anti-aliasing filter and by decimating the modified pixel block;
more than one shifted decimated instance of the pixel block is produced, each of the instances being shifted by a different number of pixels relative to the location of the pixel block in the current image, the number of pixels being smaller than the decimation factor in the direction of the shifting; and
the hierarchical search is performed using each of the shifted decimated instances of the reference image and each of the shifted decimated instances of the pixel block, thereby determining a plurality of best fitting locations, and selecting one best fitting location is based, at least in part, on using a cost function to select one best fitting location from the plurality of best fitting locations.

31. The method according to claim 30 and wherein the hierarchical search is performed using only a first portion of the shifted decimated instances of the pixel block, and only a second portion of the shifted decimated instances of the reference image, the first and the second portions being dynamically determined.

32. The method according to claim 30 and wherein the hierarchical search is performed using only a first portion of the shifted decimated instances of the pixel block, and only a second portion of the shifted decimated instances of the reference image, the first and the second portions being determined according to a first predetermined shift pattern and a second predetermined shift pattern respectively.

33. An encoder configured for compressing video, the encoder comprising a motion estimator for estimating image-to-image motion of a pixel block in a stream of video images, the stream comprising a current image which comprises the pixel block and a reference image, the motion estimator comprising:
a hierarchical search unit for performing a hierarchical search, at more than one hierarchical level, for a first candidate location in a search area of the reference image, the hierarchical search unit comprising:
a decimation unit for producing a decimated instance of the reference images and a decimated instance of the pixel block at a decimation factor decreasing according to the hierarchical level; and
a search unit for searching for a location in the search area of the decimated instance of the reference image which best fits the decimated instance of the pixel block, thereby producing a best fitting location, wherein the search area of a lower level of hierarchy is determined based, at least in part, on the best-fitting location from a higher level of hierarchy;
a first candidate unit for determining a first candidate location in the reference image which corresponds to the best fitting location;
a second candidate unit for determining a second candidate location in the reference image, the second candidate location determined by a method other than the hierarchical search;
a refined search unit for performing a search in the reference image for refined locations of the first candidate location and the second candidate location, thereby producing refined candidate locations;
a selecting unit for selecting one final location from the refined candidate locations; and
a motion estimating unit for using the final location for estimating the motion.

34. A method of producing at least one shifted decimated instance of a pixel block from a portion of an image, comprising:
modifying the portion of the image by applying an anti-aliasing filter; and
repeating, for at least one instance of integers i, j, D, and E, where 0≦1<D and 0≦j<E:
shifting a pixel block in the modified portion of the image by i pixels horizontally, and by j pixels vertically; and
decimating the shifted modified pixel block by a factor of D horizontally and by a factor of E vertically.

35. A method of comparing an instance of a first pixel block from a first image to an instance of a second pixel block in a search area in a second image, comprising:
producing a shifted decimated instance of the first pixel block from the first image by modifying a portion of the first image comprising the first pixel block by applying an anti-aliasing filter, by shifting the modified first pixel block, and by decimating the shifted modified first pixel block;
producing a shifted decimated instance of a second pixel block from the search area in the second image by applying an anti-aliasing filter, by shifting the modified second pixel block, and by decimating the shifted modified second pixel block; and
comparing the instance of the first pixel block to the instance of the second pixel block.

36. The method according to claim 35 and wherein:
more than one shifted decimated instance of the second pixel block is produced, each of the instances being shifted by a different number of pixels relative to the location of the second pixel block in the second image, the number of pixels being smaller than the decimation factor in the direction of the shifting; and
a portion of the more than one shifted decimated instances of the second pixel block are compared to the instance of the first pixel block.

37. The method according to claim 35 and wherein:
more than one shifted decimated instance of the first pixel block is produced, each of the instances being shifted by a different number of pixels relative to the location of the first pixel block in the first image, the number of pixels being smaller than the decimation factor in the direction of the shifting; and
a portion of the more than one shifted decimated instances of the first pixel block are compared to the instance of the second pixel block.

38. The method according to claim 35 and wherein:
more than one shifted decimated instance of the first pixel block is produced, each of the instances being shifted by a different number of pixels relative to the location of the first pixel block in the first image, the number of pixels being smaller than the decimation factor in the direction of the shifting;
more than one shifted decimated instance of the first pixel block is produced, each of the instances being shifted by a different number of pixels relative to the location of the first pixel block in the first image, the number of pixels being smaller than the decimation factor in the direction of the shifting; and
a portion of the more than one shifted decimated instances of the first pixel block are compared to a portion of the more than one instances of the second pixel block.

39. A method of producing at least one shifted decimated instance of an n-dimensional block from a portion of an n-dimensional array, comprising:
modifying the portion of the n-dimensional array by applying an anti-aliasing filter; and
repeating, for at least one instance:
associating a decimation factor with each of the n dimensions of the n-dimensional array,
shifting an n-dimensional block in the modified portion of the n-dimensional array by a number of pixels in each dimension, the number of pixels being smaller than the decimation factor associated with the dimension; and
decimating the shifted modified n-dimensional block in each of the n dimensions by the decimation factor associated with the dimension.

40. A method of scanning a first image comprised of pixels arrayed in M rows of N macroblocks, in order to search a second image in a search area comprising macroblocks corresponding to the macroblocks of the first image, the method comprising the steps of:
(A) loading into search memory b vertically adjacent macroblocks of the first image comprising a top left macroblock of the first image, where b>1, and loading into search memory the search area of the second image associated with the b macroblocks of the first image;
(B) performing the search for the b vertically adjacent macroblocks of the first image in the search area of the second image;
(C) loading into search memory b vertically adjacent macroblocks of the first image immediately to the right of the macroblocks searched in step (B), and loading into search memory the search area of the second image associated with the b macroblocks of step (C);
(D) repeating steps (B) and (C) until the first image has been scanned horizontally, including performing the search for the rightmost b vertically adjacent macroblocks to be loaded;
(E) loading into search memory b vertically adjacent macroblocks comprising a top left macroblock of an unscanned portion of the first image and loading into memory the search area of the second image associated with the b macroblocks of step (E); and
(F) repeating steps (B) (C) (D) and (E) until the first image has been completely scanned.

41. The method according to claim 40 and wherein the search is a motion estimation search.

42. The method according to claim 40 and wherein the macroblocks comprise macroblocks according to one of the group of image compression standards consisting of: MPEG2, MPEG4 part 2, VC1, AVC, H.263, AVS, VP6, and DivX.

43. The method according to claim 40 and wherein:
the loading into the search memory of b vertically adjacent macroblocks of the first image is performed by loading only one macroblock at a time into the search memory; and
the loading into search memory the search area of the second image associated with the b macroblocks of the first image is performed by loading all of the search area of the second image associated with the b macroblocks of the first image at the same time into the search memory.

44. The method according to claim 40 and wherein the loading into the search memory a search area of the second image associated with the b macroblocks of the first image is performed prior to loading into the search memory the b vertically adjacent macroblocks of the first image.
